(19) United States
(12) Patent Application Publication
(10) Pub. No.: US 2007/0077455 A1
(43) Pub. Date: Apr. 5, 2007

(54) Brazing techniques for dense high-fired alumina

(75) Inventors: Glenn W. Hollenberg, Kennewick, WA (US); Larry A. Bagaasen, West Richland, WA (US); Guanguang Xia, Pasco, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/241,526

(22) Filed: Sep. 30, 2005

(51) Int. Cl. C03B 29/00; B23K 31/02; B32B 19/00

(52) U.S. Cl. 428/701; 156/89.11; 156/155; 228/121

(57) ABSTRACT

The present invention discloses a refractory bond and method of making the same. The refractory bond is achieved by forming such bond between two dense ceramic parts using a lithium containing material which is reacted with at least the surface of the two dense ceramic parts. More specifically, the bond is formed of a material consisting of lithium oxide-x wherein x is the same material as the dense ceramic parts. Also preferred, but not to be limiting, the bond is in the form of lithium, and the bond together with the dense ceramic parts are in a solid solution. The invention is broadly applicable to all ceramic parts; however, preferred ceramic parts are selected form the group consisting of alumina, zirconia, titania, and magnesia.

The invention was made with Government support under Contract DE-AC0576RLO 1830, awarded by the U.S. Department of Energy. The Government has certain rights in the invention.

### TECHNICAL FIELD

This invention relates to refractory bond and method of making the same for bonding ceramic parts. More specifically, this invention relates to forming a refractory bond between two dense ceramic parts using a lithium containing material reacted with at least the surface of the two dense ceramic parts.

### BACKGROUND OF THE INVENTION

There are a great many uses for ceramic instruments in a wide variety of industrial applications. Common to many of these applications is the need to bond different ceramic parts together to form the desired product. Unfortunately, to date many of the known methods for joining one ceramic part to another ceramic part fail to form a durable bond that can withstand the sometimes harsh environments where the combination may be used.

For example, it is common to use ceramic materials as heat shields for more temperature sensitive components in kilns, furnaces, boilers and the like. In these applications, it is typical that the ceramic parts are exposed to extremely high temperatures. To prevent these high temperatures from penetrating through the ceramic parts, they must maintain structural integrity. Typically, the bond where two parts are joined is the weakest point where this structural integrity is most likely to fail.

Further complicating matters, the high temperatures typical of these applications is often accompanied by highly oxidizing or highly reducing atmospheres. These corrosive atmospheres also attack the structural integrity of bonds between ceramic parts.

Accordingly, there is a need for a refractory bond and method of making the same for joining ceramic parts that forms a strong, durable bond that will maintain structural integrity in high temperature and/or highly corrosive environments.

### SUMMARY OF THE INVENTION

It is therefore an object of the present invention to form a durable bond between two dense ceramic parts. It is a further object of the present invention to form a durable bond between two ceramic parts that will maintain structural integrity in high temperature and/or highly corrosive environments. It is a further object of the present invention to form a refractory bond between two ceramic parts that will maintain structural integrity up to the temperature that the ceramic parts begin to lose structural integrity.

These and other objects of the present invention are achieved by forming a refractory bond between two dense ceramic parts using a lithium containing material reacted with at least the surface of the two dense ceramic parts. Preferably, but not to be limiting, the bond is formed of a material consisting of lithium oxide-x wherein x is the same material as the dense ceramic parts. Also preferred, but not to be limiting, the bond is in the form of lithium, and the bond together with the dense ceramic parts are in a solid solution. The invention is broadly applicable to all ceramic parts; however, preferred ceramic parts are selected from the group consisting of alumina, zirconia, titania, and magnesia.

As contemplated by the present invention, the bond may take the form wherein the lithium oxide-x material is diffused throughout the two dense ceramic parts. Alternatively, the refractory bond may take the form wherein the lithium oxide-x material exists as a separate phase between the two dense ceramic parts. Also, the bond may exist wherein the lithium material exists as both a separate phase and as diffused throughout the dense ceramic parts.

The refractory bond described herein may be formed by the method of the present invention, which includes a pressure-assisted embodiment and a pressure-less embodiment.

In the pressurize-assisted embodiment of the present invention, two dense ceramic parts are provided. A lithium containing material is then juxtaposed between said two ceramic parts. The two dense ceramic parts are then held together with pressure and heated for a time and at a temperature sufficient to allow the lithium material to form the bond between the two dense ceramic parts.

In the pressure-less embodiment of the present invention, two dense ceramic parts are provided. A lithium containing material is then juxtaposed between said two ceramic parts. The two dense ceramic parts are then heated for a time and at a temperature sufficient to allow the lithium material to form the bond between the two dense ceramic parts.

As contemplated by the present invention, a wide variety of lithium containing materials may be used to form the bonds of the present invention in both the pressure-assisted and the pressure-less embodiments. These include, but are not limited to, lithium oxide, lithium hydroxide, lithium oxide-x wherein x is the same material as the dense ceramic parts, lithium oxide-x-hydroxide wherein x is the same material as the dense ceramic parts, lithium carbonate, lithium peroxide, lithium salts and combinations thereof.

As used herein, the phrase “form a bond” means that the lithium material reacts with the surface of the dense ceramic materials upon heating, causing them to achieve a state wherein they will effectively adhere to one and another, as both will be similarly affected. The lithium will also diffuse into the dense ceramic. In some cases this diffusion is substantially complete, such that the resulting bond between the two dense ceramic parts is a solid solution that contains no discernable separate phase. In other cases, the diffusion is not substantially complete, such that the resulting bond between the two dense ceramic parts is a solid solution that exhibits a discernable separate phase of lithium oxide-x material wherein x is the dense ceramic material. Thus, the phrase “form a bond” means that the two dense ceramic parts are made to adhere to one and another through one of the above described pathways.

As used herein a “refractory bond” is therefore two dense ceramic parts that are adhered to one and another in a manner that will allow them to remain adhered to one and another at temperatures approaching the temperature that will cause the ceramic materials to creep, form cracks, spall, deform, or otherwise experience a loss of their structural integrity.

As used herein, “dense ceramic parts” are metal oxides including metal oxides that have engineered porosity such as those described in W. D. Kingery, H. K. Bowen, and D. R. Uhlmann, Introduction to Ceramics, pg. 17. Second Edition, 1976, John Wiley & Sons, New York N.Y.

As used herein, a solid solution is where foreign atoms (in this case the lithium) are incorporated into the crystal structure of the primary material without forming a different crystalline phase as described in W. D. Kingery, H. K. Bowen, and D. R. Uhlmann, Introduction to Ceramics, pg. 131. Second Edition, 1976, John Wiley & Sons, New York N.Y.

### BRIEF DESCRIPTION OF THE DRAWINGS

The following detailed description of the embodiments of the invention will be more readily understood when taken in conjunction with the following drawing, wherein:

FIG. 1: An illustration of the pressure-assisted embodiment of the present invention.

FIG. 2: An illustration of the pressure-less embodiment of the present invention.

FIG. 3: An illustration of the interface formed during at 1300° C., 1400° C., 1450° C. and 1500° C. using the pressure assisted technique at 40 psi for 4 hours.

FIG. 4: An illustration of a prototype dense alumina microchannel device.

FIG. 5: A further illustration of shims used in a prototype dense alumina microchannel device.

### DETAILED DESCRIPTION OF THE PREFERRED EMBODIMENTS

A series of experiments were conducted to demonstrate the method of the present invention and the bonds formed thereby, which are described herein below. It should be understood that while these experiments are illustrative of specific embodiments of the present invention, the present invention contemplates embodiments beyond the specific examples described in these experiments. The skilled artisan having the benefit of this disclosure will readily recognize that the bonds formed in these experiments are simply examples of the bonds that may be formed with any of the materials set forth in the summary of the invention and the claims, and the present invention should in no way be limited to the specific materials used in these illustrative examples. Further, the skilled artisan, having the benefit of this disclosure, will also recognize that the exact parameters of variables such as of time, temperature and pressure used in these experiments are merely illustrative, and the method of the present invention should be understood to include only those limitations of these or any other variables as are set forth in the summary of the invention and the claims.

Two methods are demonstrated by these experiments; a pressure-assisted method and a pressure-less method. Both of these methods can be conducted within common furnaces available in the industry, for example, but not to be limiting, molybdenum disilicide element furnace or a typical high temperature furnace purchased from Deltech, Inc. Notably, both these methods can be practiced in an air atmosphere.

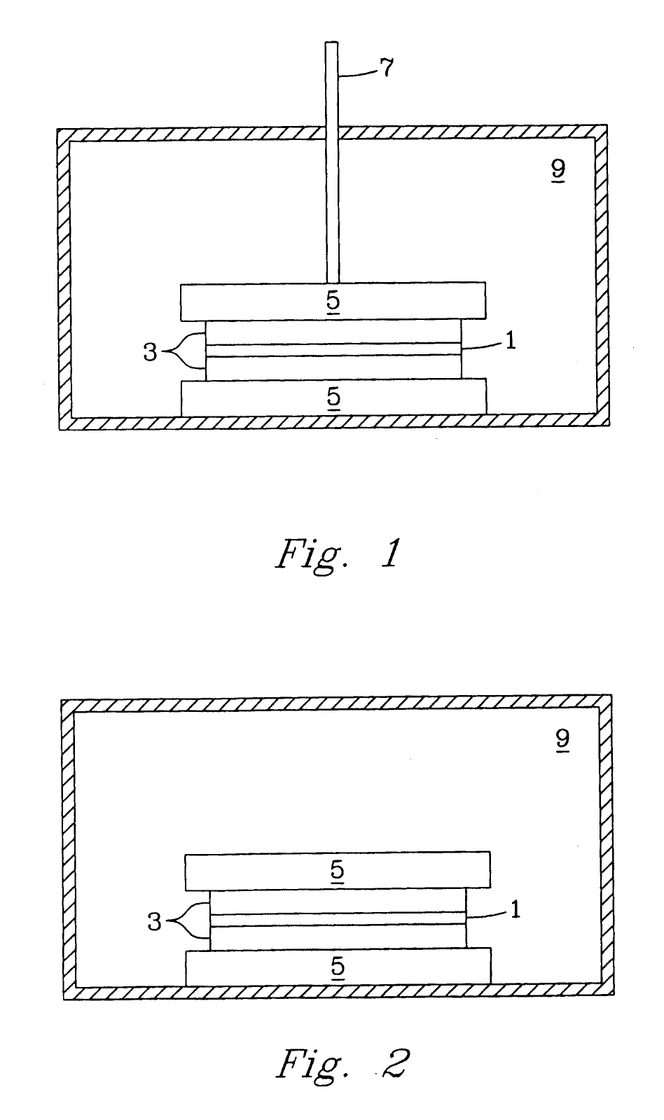

For the purposes of promoting an understanding of the principles of the invention, reference is now made to FIG. 1 which illustrates a typical pressure-assisted method using a refractory bond to bond two dense ceramic parts. The pressure-assisted method included the application of pressure on the testing samples during the heat treatment. In one example, a thin layer of LiAl₅O₈ paste 1 was applied evenly over the entire braze area of two alumina parts 3. After the paste 1 was pre-dried in air, two alumina plates 5 were positioned parallel to the parts 3 to hold the alumina parts 3 in place while pressure was applied to the sample (i.e. alumina parts and alumina plates). The plates were pressed using at least one alumina rod 7 fixed to a hydraulic piston to produce to a typical pressure of about 5 to about 70 psi. The sample was heated, using a typical furnace 9 at 1° C./min to 400° C. and held for 1 hour to burn out the binder, then heated at 3° C./min to temperatures that ranged between about 1450° C.-1500° C. and held for about 2 hours. Other lithium containing materials, including but not limited to Li₂O, Li₅AlO₄, and LiAlO₂, may also be used in the joint area in the pressure-assisted embodiments.

Another pressure-assisted method included the application of pressure on testing sample during heat treatment after a layer of LiAl₅O₈ fine powder or paste was applied to the joint area. The LiAl₅O₈ paste was formed by mixing a fine powder of LiAl₅O₈ and a commercial binder system, for example, but not to be limiting, Ferro B71757, purchased from Electronic Materials Systems, 3900 South Clinton Ave., South Plainfield, N.J. 07080. Typically, the paste was made by mixing one part of LiAl₅O₈ fine powder with 0.6 part of FERRO B71757 using a three-roll mill. After the applied paste was pre-dried in air, the sample (i.e. alumina parts and alumina plates) was pressed using an alumina rod with a pressure from about 5 to about 40 psi. The sample was heated at about 1° C./min to 400° C. and held for about 1 hour to burn out the binder, then heated at about 3° C./min to at least 1450° C. and held for about 2 hours.

The two alumina plates and two alumina parts used in these exemplary pressure-assisted experiments can be purchased from Coors Ceramic, Golden, Colo. The alumina parts are typically 1″×¼″×⅛″ in dimension. The thick alumina plates are typically 2″×2″×¾″ in dimension.

With the application of pressure and a compound with low lithium content, a joint with little porosity may be formed as the diffusion of lithium into the surrounding alumina occurs.

In still another embodiment of the pressure-assisted invention, a seamless bond is formed between the alumina parts by using LiAl₅O₈ as a brazing compound. Bond strengths in excess of about 6000 psi are obtained with this method at heat treatment temperatures of about 1500° C. The bond strength of a test sample was determined using a shear strength measurement setup. During the shear strength measurements, the alumina bars were placed into a sample holder which was secured to a support. A compression force was then gradually exerted on the bars parallel to the joint interface at room temperature until the joint was broken or the maximum force of the test device had been reached. The area of the joint interface is used to calculate the shear strength from the applied load at failure or the maximum load. The shear test described above was the typical shear strength test applied to all the samples disclosed in this invention to determine the bond strengths for all the refractory bonds described herein.

In a still further embodiment of the present invention, the pressure-less method involves placing a fine powder or paste of a relatively low melting point lithium containing materials, for example and not meant to be limiting, Li₅AlO₄ between the two alumina parts. The Li₅AlO₄ powder is prepared by the reaction of a mixture of lithium and/or aluminum bearing materials with the overall Li/Al ratio of 5 at a temperature from 750° C. to 1000° C. for 4 hours in an alumina crucible. The mixture can be formed including, but not limited to, the following ingredients: one molar of LiAlO₂ and two molar of LiOH, one molar of LiAlO₂ and two molar of Li₂O, one molar of LiAlO₂ and two molar of Li₂CO₃. The reaction products from these mixtures may also contain Li₂CO₃, LiAlO₂, or LiAl₅O₈ in pure phases, besides Li₅AlO₄ phase. The powder may be substituted with a water based Li₅AlO₄ paste. Typically, the paste is formed by mixing a small amount of water with the Li₅AlO₄ powder.

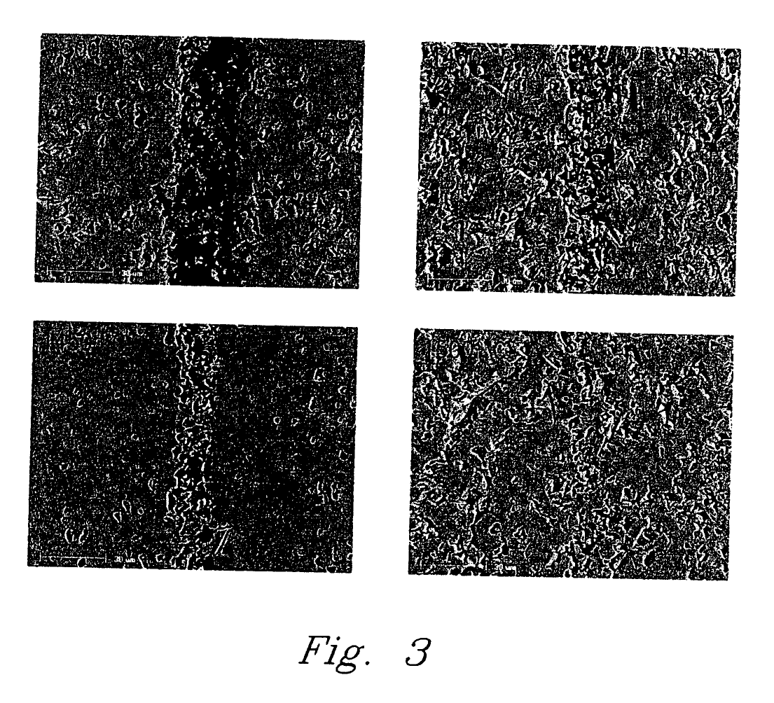

Reference is now made to FIG. 2 which illustrates a typical pressure-less method of using a refractory bond to bond two dense ceramic parts. In one experiment demonstrating the pressure-less method, a layer of Li₅AlO₄ powder or paste 1 was applied to the braze area between two alumina parts 3. The alumina parts 3 where then heated to about 1200° C. temperature plateau where the Li₅AlO₄ powder melted and wetted the surface of the alumina parts. Two alumina plates 5 hold the alumina bars 3 in place. The Li₅AlO₄ reacts with the alumina parts to form lithium aluminate compounds with higher Al/Li ratios than the precursor Li₅AlO₄ powder. The thermal treatment forms strong bonds with a final bond zone being comprised of predominately LiAlO₂.

The two alumina parts 3 and alumina plates 5 used in these exemplary pressure-less experiments can be purchased from Coors Ceramic, Golden, Colo. As previously stated, the alumina parts are typically 1″×¼″×⅛″ in dimension and the alumina plates are typically 2″×2″×¾″ in dimension. A typical furnace as described herein can be used to heat the sample in a typical pressure-less embodiment of the present invention.

### EXAMPLE 1

The pressure-assisted method included the application of pressure on testing samples during heat treatment after a layer of LiAl₅O₈ fine powder or paste was applied to the joint area. The LiAl₅O₈ paste was formed by mixing the fine powder of LiAl₅O₈ and a binder system, for example, Ferro B71757. LiAl₅O₈ powder is insoluble in water and does not react with the organic based binder system. After the applied paste was pre-dried in air for about 4 hours, the specimen was pressed using an alumina rod with a pressure of about 5 to about 40 psi. The sample was heated at 1° C./min to 400° C. and held for 1 hour to burn out the binder, then heated at 3° C./min to 1450° C.-1500° C. and held for 2 hours. The bonding strength is higher than 6000 psi as determined by the shear strength method test described herein.

### EXAMPLE 2

In another example of the pressure-less method involved applying a thin layer of Li₅AlO₄ fine powder or paste evenly over the entire braze area of two dense alumina bars (1″×¼″×⅛″ each) and heating the substrates at 10° C./min to 1200° C. and holding at the temperature for a period in the range of about 2-12 hours. At the 1200° C. temperature plateau, the Li₅AlO₄ powder melts and wets the surface of the fired alumina bars and starts to react to form other lithium aluminate compounds with higher Al/Li ratio to the precursor Li₅AlO₄ powder. The bonding strength of the sample was about 725 psi using a shear strength measurement. The brazed interface consists of mainly LiAlO₂ phase with less than 20% of LiAl₅O₈ phase identified by X-ray diffraction (XRD) analysis.

### EXAMPLE 3

In a further example of the pressure-less method also involved placing a thin layer of Li₅AlO₄ fine powder or paste in the braze area of two dense alumina parts and heating the substrates at 10° C./min to 1400° C. and holding at that temperature for 12 hours. The high temperature refractory LiAl₅O₈ was dominantly formed at the brazed interface. The bonding strength of the test sample was less than 725 psi using a shear strength method test.

### EXAMPLE 4

In a still further example of the pressure-less method involved applying a thin layer of Li₅AlO₄ fine powder or paste evenly over the entire braze area of two dense alumina parts and heating the substrates at 10° C./min to 1200° C. and holding at the temperature for 2 hours followed by a final heat treatment at 1600° C. for 2 hours. The bonding strength of the sample is about 725 psi using a shear strength measurement. The high temperature refractory LiAl₅O₈ was dominantly formed at the brazed interface.

### EXAMPLE 5

In one example use of the present invention, refractory bonds are used to bond dense ceramic components for example, but not to be limiting to microchannel devices. In a typical example, the heat exchanger consists of three separating shims, two channel shims, and two headers. These components may be fabricated using tape-casting method followed by patterning and densifying steps. A thick film ceramic tape was created using Rhomm & Haas B-1000 aqueous binder system, Alcoa A-16 Super Grind Alumina powder (A16SG), and R. T. Vanderbuilt's Darvan-C dispersant. De-ionized water, Darvan-C and the A16SG were combined in a polypropylene container with ⅜″ diameter Zirconia ball milling media. The contents were ball milled at high speed for about 2 days, then the B-1000 was added and the slurry was transferred to a slow speed roller and rolled for at least 1 day prior to casting.

Tape casting of the thick film was performed using a Tapecast Warehouse 5 foot long moving carrier film caster. The tape was cast on the uncoated side of 12 inch wide Silicone coated mylar. Tape thickness was targeted at 600-700 μm cast thickness. After casting, the tape was allowed to dry on the caster overnight.

Parts were cut from the dried tape using an Epilog Laser 35 watt laser cutter. Part size was dictated by the desired shape needed, and sintering shrinkages in the x and y directions. Sintering shrinkages were calculated from initial sintering runs to determine the green size of the parts.

The green parts were placed on a flat surface refractory block and fired up to 1520° C. (1° C./min from room temperature to 400° C. and hold for 1 hour, then heated at 3° C./min to 1520° C. and hold for 2 hours. The fired parts were further flattened by placing a light refractory plate on the parts and heating up to 1550° C. for 1 hour. The shrinkage of the green parts were about 20%. The LiAl₅O₈ paste was juxtaposed between the dense ceramic components. After the applied paste was pre-dried in air for about 4 hours, the ceramic components were pressed using an alumina rod with a pressure of about 5 to about 40 psi. The ceramic components were heated at 1° C./min to 400° C. and held for 1 hour to burn out the binder, then heated at 3° C./min to 1450° C.-1500° C. and held for 2 hours.

The stacked microchannel heat exchanger may include several vertically stacked layers of generally rectangular microchannels having open ends and extending the length of the heat exchanger. The dimensions of the microchannels, the number of vertical stacked microchannel layers and the total number of microchannels can vary depending on the needs. The heat exchanger in this example is illustrative of one of the many uses of the present invention. The heat exchanger may be formed using one of the many well-known techniques common to industry practices. For example, single layers of microchannels may be formed using techniques including but not limited to micromachining, chemical etching and laser ablation.

FIG. 3 illustrates the interface formed at 1300° C., 1400° C., 1450° C. and 1500° C. using the pressure assisted technique at 40 psi for 4 hours. The samples (1″× 1/4″× 1/8″ each) were cut from alumina plates that purchased from Coors Ceramic, Golden, Colo.

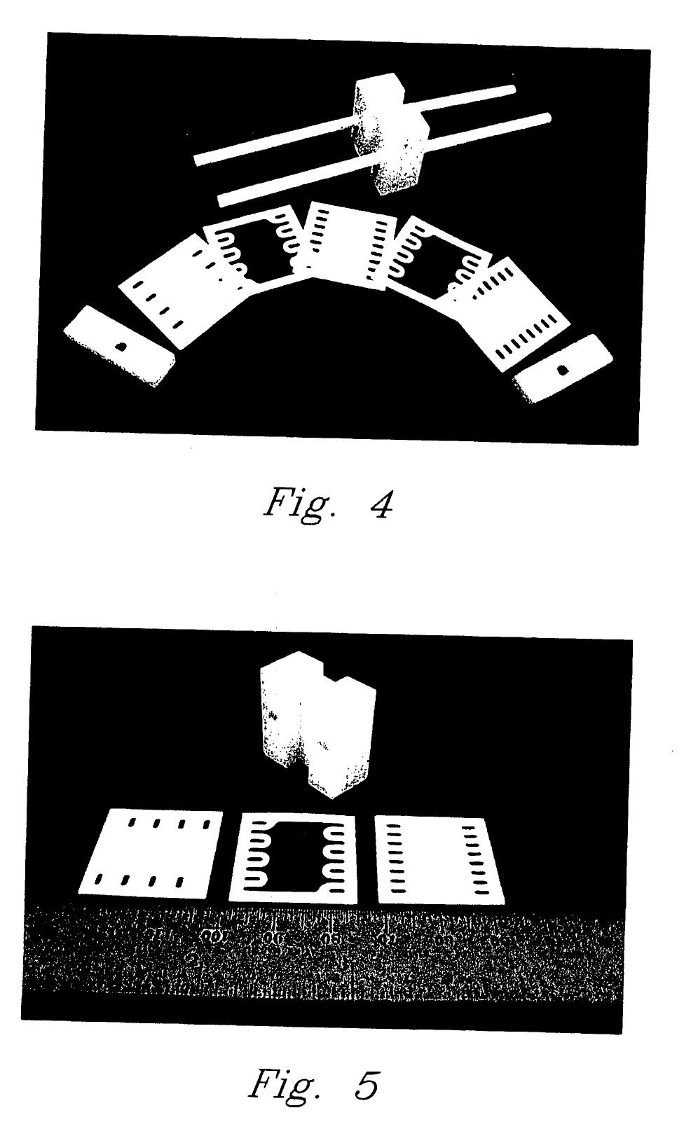

FIGS. 4 and 5 illustrate a prototype of a dense alumina microchannel device, i.e., a heat exchanger that has been successfully fabricated using the pressure-assisted method.

While objects of the present inventions described herein are shown and described, it will be apparent to those skilled in the art that many changes and modifications may be made without departing from the spirit of the invention in its broader aspects. The appended claims are therefore intended to cover all such changes and modifications as fall within the true spirit and scope of the invention.

1-6. (canceled)

7. A method of forming a refractory bond between two dense ceramic parts comprising the steps of:
providing two dense ceramic parts, wherein the dense ceramic parts comprise refractory oxides having a composition, x;
providing a lithium material juxtaposed between said dense ceramic parts, wherein said lithium material is substantially lithium oxide-x; and
heating said dense ceramic parts for a time and at a temperature sufficient to allow said lithium material to form a refractory bond between said two dense ceramic parts.

8. (canceled)

9. The method in claim 7 wherein the refractory bond comprises a solid solution of lithium oxide and x.

10. The method of claim 7 wherein said dense ceramic parts are selected from the group consisting of alumina, zirconia, titania, and magnesia.

11. (canceled)

12. The method of claim 7 wherein said lithium oxide-x is substantially completely diffused into said two dense ceramic parts.

13. The method of claim 7 wherein the refractory bond comprises a substantially separate phase of lithium oxide-x between the two dense ceramic parts.

14. (canceled)

15. A method of forming a refractory bond between two dense ceramic parts comprising the steps of:
providing two dense ceramic parts, wherein the dense ceramic parts comprise refractory oxides having a composition, x;
providing a lithium material juxtaposed between said dense ceramic parts, wherein said lithium material is substantially lithium oxide-x;
providing pressure to said dense ceramic parts, and
heating said dense ceramic parts for a time and at a temperature sufficient to allow said lithium material to form a refractory bond between said two dense ceramic parts.

16. (canceled)

17. The method in claim 15 wherein the refractory bond comprises a solid solution of lithium oxide and x.

18. The method of claim 15 wherein said dense ceramic parts are selected from the group consisting of alumina, zirconia, titania, and magnesia.

19. (canceled)

20. The method of claim 15 wherein said lithium oxide-x is substantially completely diffused into said two dense ceramic parts.

21. The method of claim 19 wherein the refractory bond comprises a substantially separate phase of lithium oxide-x between the two dense ceramic parts.

22. (canceled)

23. The method of claim 15, wherein the two dense ceramic parts comprise aluminum oxide and said lithium material comprises lithium oxide-aluminum oxide.

24. The method of claim 23, wherein said lithium oxide-aluminum oxide is LiAl₅O₈, Li₅AlO₄, LiAlO₂, or combinations thereof.

25. The method of claim 7, wherein the two dense ceramic parts comprise aluminum oxide and said lithium material comprises lithium oxide-aluminum oxide.

26. The method of claim 25, wherein said lithium oxide-aluminum oxide is LiAl₅O₈, Li₅AlO₄, LiAlO₂, or combinations thereof.
